(19) United States
(12) Patent Application Publication
(10) Pub. No.: US 2015/0042776 A1
(43) Pub. Date: Feb. 12, 2015

(54) Systems And Methods For Detecting A Specular Reflection Pattern For Biometric Analysis

(71) Applicant: Morpho Trust USA,LLC, Billerica, MA (US)

(72) Inventor: Matthew Davis, Milpitas, CA (US)

(21) Appl. No.: 14/127,242

(22) PCT Filed: Jun. 18, 2012
(86) PCT No.: PCT/US12/42904

§ 371 Date: Oct. 8, 2014

Related U.S. Application Data
(60) Provisional application No. 61/498,529, filed on Jun. 18, 2011.

(51) Int. Cl. G06K 9/00; H04N 5/232

(52) U.S. Cl. CPC G06K 9/00604; G06K 9/0061; H04N 5/23219
USPC 348/78

(57) ABSTRACT

Embodiments provide rapid detection of specular reflection patterns in eye images, which can then be analyzed to determine the quality of the image for biometric analysis. For example, systems and methods receive at least one image of an eye from an image capture system. The image capture system includes a camera and one or more illuminators that direct light at the eye while the camera captures the at least one image. The eye reflects the light from the illuminators to create a specular reflection pattern in the at least one image. The specular reflection pattern is located/identified and a quality of the at least one image of the eye, e.g., a focus measure, is determined based on the specular reflection pattern. A location of iris texture in the at least one image may be identified according to a location of the specular reflection pattern and analyzed for a focus measure.

### CROSS-REFERENCE TO RELATED APPLICATIONS

This application claims the benefit of, and priority to, U.S. Provisional Patent Application Ser. No. 61,498,529, filed Jun. 18, 2011, the contents of which are incorporated entirely herein by reference.

### FIELD OF THE INVENTION

The present invention relates generally to systems and methods for processing images to obtain biometric information, and more particularly, to systems and methods for rapidly detecting specular reflection patterns in eye images, which can then be analyzed to determine the quality of the image for biometric analysis.

### BACKGROUND OF THE INVENTION

Biometric iris image capture systems typically consist of a video camera which produces a stream of video frames and a set of illuminators in fixed locations relative to the camera which provide the light necessary to produce high quality images. In order to capture high quality images, the quality of the images in the video stream must be assessed. These quality results can be used to provide feedback to users, drive autofocus or camera pan/tilt mechanisms, or determine which frames from the video stream are likely to be useful for matching.

Among the most important metrics for quality assessment is image focus—specifically the sharpness of the iris texture and pupil boundary. Cameras for capturing images of the iris tend to have a shallow depth of field, and irises are surrounded by confounding image features such as eyelashes and eyebrows. General image sharpness algorithms often respond to these confounding features while leaving the iris texture itself out of focus. In addition, the iris is typically a moving target due to motion of the capture subject, the camera operator, or both. This means that focusing on a fixed location within the image is unlikely to produce reliable focus results.

To achieve rapid detection of candidate images and obtain feedback for camera control operations, a reliable focus assessment algorithm should be able to locate the region of interest, i.e., iris texture, within an image and assesses the focus in that region within the time of a single video frame. Focus assessment algorithms that apply to fixed image regions can be readily implemented. However, algorithms for locating irises tend to require significant processing time, making them ill-suited for embedded processor or high rate applications.

### SUMMARY

Embodiments according to aspects of the present invention provide rapid detection of specular reflection patterns in eye images, which can then be specifically analyzed to determine the quality of the image for biometric analysis.

For example, systems and methods according to aspects of the present invention receive at least one image of an eye from an image capture system. The image capture system includes a camera and one or more illuminators that direct light at the eye while the camera captures the at least one image of the eye. The eye reflects the light from the one or more illuminators to create a pattern of one or more specular reflections in the at least one image. Using a controller, for example, the specular reflection pattern in the at least one image of the eye is identified and a quality of the at least one image of the eye is determined based on the specular reflection pattern.

In further embodiments, the specular reflection pattern in the at least one image is located. A location of iris texture in the at least one image may be identified according to the location of the specular reflection pattern. In addition, the quality of the at least one image may be determined by analyzing a focus measure based on the located iris texture.

In additional embodiments, the quality of the at least one image is determined by analyzing a focus measure for the at least one image according to other techniques. The focus measure for the at least one image, for example, may be determined by analyzing a sharpness of one or more of the specular reflections, which is determined by measuring a size of the one or more specular reflections.

In other embodiments, the quality of the at least one image is determined by analyzing an intensity of areas surrounding the one or more specular reflections in the at least one image to determine a location of the one or more specular reflections relative to features of the eye.

In further embodiments, the quality of the at least one image is determined by analyzing an occlusion of the one or more specular reflections in the at least one image.

In additional embodiments, a type of image capture system is determined according to the specular reflection pattern and the at least one image is analyzed according to the type of image capture system.

In yet other embodiments, information relating to the quality of the at least one image is sent to the image capture system, and the image capture system is adjusted according to the quality information.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 illustrates an image capture system that may be implemented according to aspects of the present invention.

FIG. 2 illustrates an example embodiment implementing steps according to aspects of the present invention.

FIG. 3 illustrates an example embodiment implementing further steps according to aspects of the present invention.

FIG. 4A illustrates an example eye image where the eye is looking generally straight toward the camera and there are no occlusions.

FIG. 4B illustrates example areas where iris texture is expected to be in an eye image according to aspects of the present invention.

FIG. 5 illustrates an example eye image that is out of focus.

FIG. 6 illustrates an example eye image where the iris has rolled upward relative to specular reflections.

While the invention is susceptible to various modifications and alternative forms, specific embodiments have been shown by way of example in the drawings and will be described herein. It should be understood, however, that the invention is not intended to be limited to the particular forms disclosed. Rather, the invention is to cover all modifications, equivalents, and alternatives falling within the spirit and scope of the invention as defined by the appended claims.

### DESCRIPTION

According to aspects of the present invention, systems and methods employ an efficient object detection procedure that rapidly detects specular reflection patterns in eye images, which can then be analyzed to determine the quality of the image for biometric analysis.

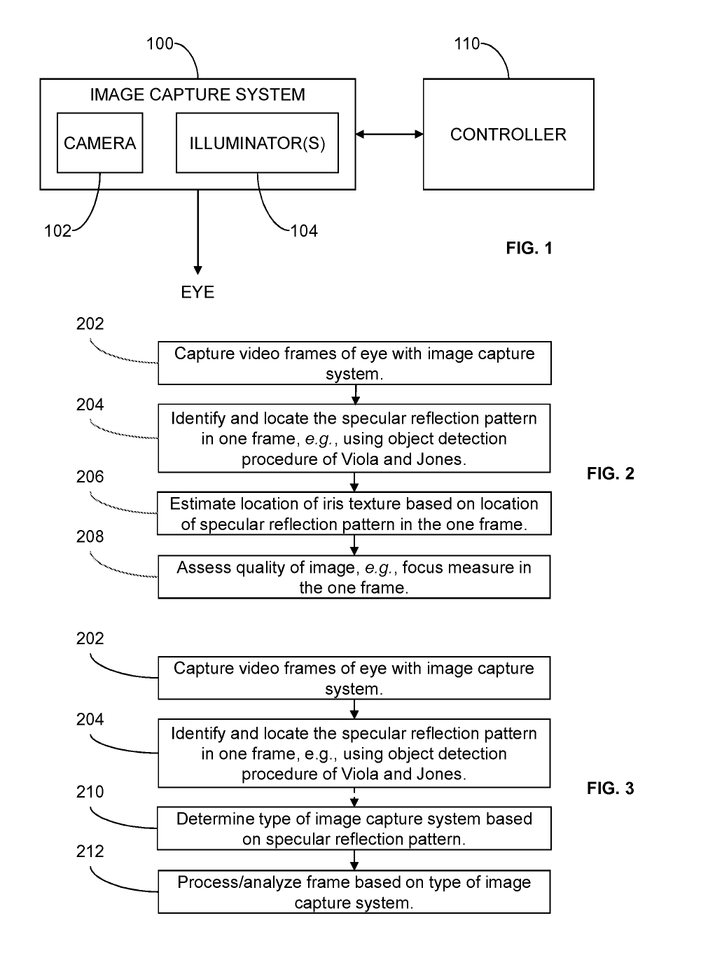

Referring to FIG. 1, an image capture system 100 is illustrated. The image capture system 100 includes a camera 102 and a set of illuminators 104 that are employed to capture a stream of video frames of an eye including iris texture. FIG. 1 also illustrates a controller 110 coupled to the image capture system 100. The controller 110 processes the video frames from the image capture system 100 and may also control aspects of the operation of the image capture system 100. In particular, the controller 110 assesses whether the quality of a video frame is sufficient for further biometric analysis. In some cases, the controller 110 uses the quality assessment to provide feedback to the image capture system 100 so that higher quality images can be captured, e.g., by adjusting autofocus, camera pan/tilt mechanisms, or the like.

In an example application illustrated in FIG. 2, a stream of video frames of the eye, including iris texture, are captured in step 202 with the image capture system 100. During step 202, the illuminators 104 produce a fixed pattern of specular reflection on the surface of the eye. Accordingly, in step 204, a procedure for object detection is applied to the video frames to identify and locate the specular reflection pattern. To make the detection of the specular reflection pattern easier and more reliable, the set of illuminators 104 in some embodiments may be arranged to make the specular reflection pattern easier to distinguish. For example, a single illuminator 104 generally produces a single bright spot, whereas four illuminators produce four spots in a fixed pattern which may be more easily distinguishable, for example, from background glare.

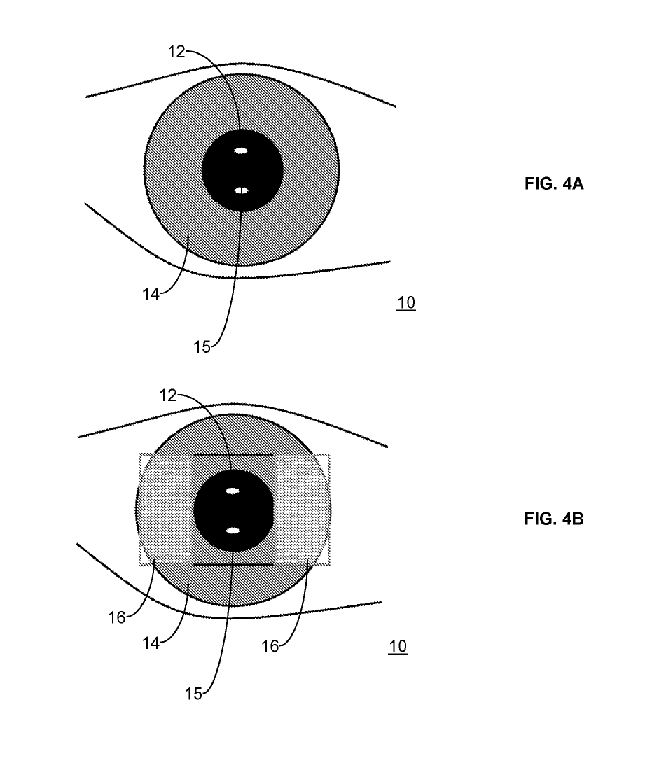

The location of the eye can be determined from the location of the specular reflection pattern as the specular reflection pattern always appears in the eye, which acts as a reflective sphere. From the location of the eye and the geometry of the image capture system 100, the location of the iris texture in the eye image can then be estimated in step 206. An example of a typical eye image 10 is shown in FIG. 4A. The eye image 10 is produced when the eye is looking generally straight toward the camera 102. The two specular reflections 15 (bright spots) appear within the pupil 12 and do not obscure the iris 14. In the eye image 10, the iris texture can be assumed to be in a generally fixed location relative to the specular reflection pattern. FIG. 4B illustrates the estimated location of the iris texture in the areas 16.

Once the iris texture has been located, a quality assessment procedure, e.g., focus measurement, can be specifically applied in step 208 to the iris region of interest. Step 208, as well as steps 204 and 206, are executed by the controller 110.

An example procedure for measuring focus is described in U.S. Pat. No. 6,753,919 to Daugman, the contents of which are incorporated entirely herein by reference. Unlike other implementations of this focus measurement procedure, however, the focus here is assessed for a region of interest as determined by the location of the specular reflection pattern.

Aspects of a robust and extremely rapid object detection procedure for step 20 are described in Viola, P. and Jones, M., “Rapid Object Detection using Boosted Cascade of Simple Features,” Proceedings IEEE Conf. on Computer Vision and Pattern Recognition (2001) (hereinafter, “Viola and Jones”), the contents of which are incorporated entirely herein by reference. The object detection procedure achieves high frame rates by only working with information present in a single grey scale image. The object detection procedure classifies images based on the values of simple features. In particular, the values of a set of rectangle features, reminiscent of Haar basis functions, are calculated for the image. Different sets of rectangle features may be employed. The use of rectangle features is particularly successful in the embodiments described herein, because specular reflections on a pupil may strongly resemble black and white rectangular structures. Rapid computation of the rectangular features is achieved by using an intermediate image representation, referred to as “an integral image.” A variant of AdaBoost (Adaptive Boosting) is then employed as a learning algorithm to select a small set of important visual features and to produce efficient classifiers. Additionally, combining increasingly more complex classifiers in a cascade structure increases the speed of the object detector by focusing attention on promising regions of the image. In step 204, the object detector finds the specular reflection pattern rapidly by focusing on areas of the image where the pattern is likely to be located. Thus, according to aspects of the present invention, the specular reflection pattern of a particular image capture system can be described very efficiently in this object detection procedure and can be used to track the eye with a high degree of accuracy with minimal computation.

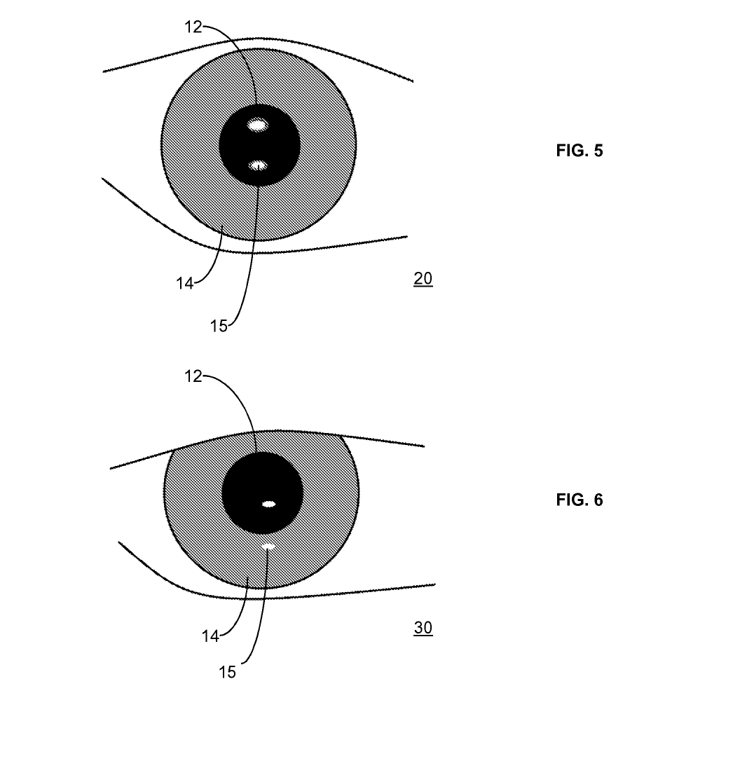

Another additional technique for measuring focus may involve examining the sharpness of the specular reflections. As the image comes into focus, the edges of the specular reflections become sharper and overall area of each specular reflection becomes smaller. FIG. 5 illustrates an example of how specular reflections 15 appear in an out of focus eye image 20. The area of each specular reflection is larger and the edges of each specular reflection are more diffused. Indeed, in some cases, focus can be successfully determined by ignoring the iris texture for focus measurement and merely assuming that the sharpest image among the captured video frames is the image with smallest specular reflections. Because the specular reflections provide information on image focus, the object detector can be calibrated to respond most strongly to the specular reflection pattern when the iris texture is at peak focus.

In FIG. 4A, the eye is looking generally straight toward the camera. If, however, the subject rolls his or her eye upward, the eye capture system 100 may capture an eye image 30 as shown in FIG. 6. The specular reflections 15 remain in the same place relative to the eye in general as shown in FIG. 4A, but the iris 14 has moved upward so that the reflections 15 are now positioned over the iris 14. Because the object detector attempts to identify specular reflections 15 relative to a dark background, such as the pupil 12, the eye image 30 in FIG. 5 does not receive a high quality score, thereby eliminating the eye image 30 as a candidate for further analysis. Thus, the intensity of the pixels surrounding the specular reflection can be used to determine whether the iris is centered or rolled to one side. When the subject blinks and occludes the iris, the specular reflections are often occluded as well, also resulting in a low quality score that eliminates the image as a candidate, whereas the quality score of a more general focus metric might not be affected by the occlusion. In general, the overall quality of an image is a combination of how well the specular reflections match up with an expected (or acceptable) image as well as how sharp the iris texture appears to be.

As described above, the illuminators 104 of the image capture system 110 produce a fixed pattern of specular reflection on the surface of the eye. As such, the specular reflection pattern indicates what type of image capture system 100, including the model of the camera 102, is being used to obtain the images. Because embodiments according to the present invention can identify different specular reflection patterns, information on the detected specular reflection pattern can also be employed to identify the type of image capture system 100 used to obtain the images. Referring to the example application illustrated in FIG. 3, the specular reflection is identified in step 204 using the object detection procedure above. In step 210, the specular reflection pattern is used to determine the corresponding image capture system 100, e.g., by referring to a database of known specular reflection patterns. Subsequent processing or analysis particular to the image capture system 100 is then performed in step 212.

FIG. 1 illustrates the controller 110 for processing the video frames from the image capture system 100 using algorithms and optionally providing feedback to the image capture system 100. Generally, the controller 110 may be implemented as a combination of hardware and software elements. The hardware aspects may include combinations of operatively coupled hardware components including microprocessors, logical circuitry, communication/networking ports, digital filters, memory, or logical circuitry. The controller may be adapted to perform operations specified by a computer-executable code, which may be stored on a computer readable medium. The controller 110 may be a programmable processing device, such as an external conventional computer or an on-board field programmable gate array (FPGA) or digital signal processor (DSP), that executes software, or stored instructions. In general, physical processors and/or machines employed by embodiments of the present disclosure for any processing or evaluation may include one or more networked or non-networked general purpose computer systems, microprocessors, field programmable gate arrays (FPGA's), digital signal processors (DSP's), micro-controllers, and the like, programmed according to the teachings of the exemplary embodiments, as is appreciated by those skilled in the computer and software arts. The physical processors and/or machines may be externally networked with the image capture system 100, or may be integrated to reside within the image capture system 100. Appropriate software can be readily prepared by programmers of ordinary skill based on the teachings of the exemplary embodiments, as is appreciated by those skilled in the software art. In addition, the devices and subsystems of the exemplary embodiments can be implemented by the preparation of application-specific integrated circuits or by interconnecting an appropriate network of conventional component circuits, as is appreciated by those skilled in the electrical art(s). Thus, the exemplary embodiments are not limited to any specific combination of hardware circuitry and/or software. Stored on any one or on a combination of computer readable media, the exemplary embodiments may include software for controlling the devices and subsystems of the exemplary embodiments, for driving the devices and subsystems of the exemplary embodiments, for enabling the devices and subsystems of the exemplary embodiments to interact with a human user, and the like. Such software can include, but is not limited to, device drivers, firmware, operating systems, development tools, applications software, and the like. Such computer readable media further can include the computer program product of an embodiment for performing all or a portion (if processing is distributed) of the processing performed in implementations. Computer code devices of the exemplary embodiments can include any suitable interpretable or executable code mechanism, including but not limited to scripts, interpretable programs, dynamic link libraries (DLLs), Java classes and applets, complete executable programs, and the like. Moreover, parts of the processing of the exemplary embodiments of the present disclosure can be distributed for better performance, reliability, cost, and the like. Common forms of computer-readable media may include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave or any other suitable medium from which a computer can read.

While the invention is susceptible to various modifications and alternative forms, specific embodiments and methods thereof have been shown by way of example in the drawings and are described in detail herein. It should be understood, however, that it is not intended to limit the invention to the particular forms or methods disclosed, but, to the contrary, the intention is to cover all modifications, equivalents and alternatives falling within the spirit and scope of the invention. For example, although the embodiments herein may relate to analysis of the iris, aspects of the present invention may be applied to other features of the eye or body.

What is claimed is:

1. A method for biometric analysis, comprising:
receiving at least one image of an eye from an image capture system, the image capture system including a camera and one or more illuminators that direct light at the eye while the camera captures the at least one image of the eye, the eye reflecting the light from the one or more illuminators to create a pattern of one or more specular reflections in the at least one image;
identifying, with a controller, the specular reflection pattern in the at least one image of the eye; and
determining, with the controller, a quality of the at least one image of the eye based on the specular reflection pattern.

2. The method according to claim 1, further comprising determining a location of the specular reflection pattern in the at least one image.

3. The method according to claim 2, further comprising determining a location of iris texture in the at least one image according to the location of the specular reflection pattern.

4. The method according to claim 3, wherein determining the quality of the at least one image includes determining a focus measure based on the located iris texture.

5. The method according to claim 1, wherein determining the quality of the at least one image includes determining a focus measure for the at least one image.

6. The method according to claim 5, wherein determining the focus measure for the at least one image includes determining a sharpness of one or more of the specular reflections by measuring a size of the one or more specular reflections.

7. The method according to claim 1, wherein determining the quality of the at least one image includes determining an intensity of areas surrounding the one or more specular reflections in the at least one image to determine a location of the one or more specular reflections relative to features of the eye.

8. The method according to claim 1, wherein determining the quality of the at least one image includes determining an occlusion of the one or more specular reflections in the at least one image.

9. The method according to claim 1, further comprising determining a type of image capture system according to the specular reflection pattern and analyzing the at least one image according to the type of image capture system.

10. The method according to claim 1, further comprising sending, to the image capture system, information relating to the quality of the at least one image, the image capture system being adjusted according to the quality information.

11. A system for biometric analysis, comprising:
an image capture system that captures at least one image of an eye, the image capture system including a camera and one or more illuminators that direct light at the eye while the camera captures the at least one image of the eye, the eye reflecting the light from the one or more illuminators to create a pattern of one or more specular reflections in the at least one image; and
a controller that identifies the specular reflection pattern in the at least one image of the eye and determines a quality of the at least one image of the eye based on the specular reflection pattern.

12. The system according to claim 11, wherein the controller further determines a location of the specular reflection pattern in the at least one image.

13. The system according to claim 12, wherein the controller further determines a location of iris texture in the at least one image according to the location of the specular reflection pattern.

14. The system according to claim 13, wherein the controller determines the quality of the at least one image by determining a focus measure based on the located iris texture.

15. The system according to claim 11, wherein the controller determines the quality of the at least one image by determining a focus measure for the at least one image.

16. The system according to claim 15, wherein the controller determines the focus measure for the at least one image by determining a sharpness of one or more of the specular reflections by measuring a size of the one or more specular reflections.

17. The system according to claim 11, wherein the controller determines the quality of the at least one image by determining an intensity of areas surrounding the one or more specular reflections in the at least one image to determine a location of the one or more specular reflections relative to features of the eye.

18. The system according to claim 11, wherein the controller determines the quality of the at least one image by determining an occlusion of the one or more specular reflections in the at least one image.

19. The system according to claim 11, wherein the controller determines a type of image capture system according to the specular reflection pattern and analyzes the at least one image according to the type of image capture system.

20. The system according to claim 11, wherein the controller sends, to the image capture system, information relating to the quality of the at least one image, the image capture system being adjusted according to the quality information.
